(19) United States
(12) Patent Application Publication
(10) Pub. No.: US 2026/0343470 A1
(43) Pub. Date: Oct. 29, 2026

(54) METHODS AND APPARATUSES FOR RADIO LINK MANAGEMENT

(71) Applicant: LENOVO (BEIJING) LIMITED, Beijing (CN)

(72) Inventors: Min Xu, Beijing (CN); Lianhai Wu, Beijing (CN); Ran Yue, Beijing (CN); Jing Han, Beijing (CN); Jie Hu, Beijing (CN)

(21) Appl. No.: 19/113,010

(22) PCT Filed: Dec. 2, 2022
(86) PCT No.: PCT/CN2022/136271

§ 371 Date: Mar. 19, 2025

(51) Int. Cl. H04W 64/00; H04W 24/08; H04W 24/10; H04W 56/00; H04W 76/19

(52) U.S. Cl. CPC H04W 64/00; H04W 24/08; H04W 24/10; H04W 56/0045; H04W 76/19

(57) ABSTRACT

The present application relates to methods and apparatuses for radio link management. An embodiment of the present disclosure provides a user equipment (UE), comprising: a transceiver; and a processor coupled with the transceiver and configured to: determine a positioning gap configuration for positioning of the UE; perform radio link management associated with the positioning gap configuration; and determine a position of the UE during the positioning gap.

### TECHNICAL FIELD

The present disclosure relates to wireless communication, and particularly relates to methods and apparatuses for radio link management.

### BACKGROUND OF THE INVENTION

In a non-terrestrial network (NTN), a typical global navigation satellite system (GNSS) operation, for example, a GNSS position fix operation, may take seconds or tens of seconds. However, there are restrictions on simultaneous GNSS operations and data transmissions or receptions. For example, for a Rel-17 internet of things (IoT) NTN user equipment (UE), it may not perform GNSS operation and data transmission or reception simultaneously. Accordingly, the UE may leave the radio resource control (RRC)_CONNECTED state to perform a GNSS operation.

It is desirable to provide methods and apparatuses for radio link management, that may allow the UE to perform a GNSS operation and remain in the RRC_CONNECTED state.

### SUMMARY

An embodiment of the present disclosure provides a UE, comprising: a transceiver; and a processor coupled with the transceiver and configured to: determine a positioning gap configuration for positioning of the UE; perform radio link management associated with the positioning gap configuration; and determine a position of the UE during the positioning gap.

In some embodiments, the UE is in a radio resource control (RRC)_CONNECTED state.

In some embodiments, the positioning of the UE includes GNSS positioning or non-GNSS positioning.

In some embodiments, the radio link management is performed based on configuration information received from a BS, based on UE implementation, or based on pre-configured rules.

In some embodiments, the positioning is performed based on the positioning gap configuration received from a base station (BS), or based on movement of the UE.

In some embodiments, in the case that the positioning gap is configured, the radio link management is associated with a radio link control process, which includes at least one of the following: disabling all access stratum (AS) functions before or at the beginning of the positioning gap; enabling all AS functions at or after the end of the positioning gap; disabling radio problem detection or radio link monitoring before or at the beginning of the positioning gap; enabling radio problem detection or radio link monitoring at or after the end of the positioning gap; applying an extended value to a counter N310 before or at the beginning of the positioning gap; applying an extended value to a timer T310 before or at the beginning of the positioning gap; or suspending transmission of an RRC reestablishment request until the end of the positioning gap; transmitting the RRC reestablishment request before or at the beginning of the positioning gap, including an indication which indicates the BS to suspend a response to the RRC reestablishment request until the end of the positioning gap; transmitting a random access preamble using a dedicated physical random access channel (PRACH) resource at or after the end of the positioning gap; or applying an extended value to a timer T301 before or at the beginning of the positioning gap.

In some embodiments, the radio link control process further includes: starting the counter N310 from value 0 after enabling radio problem detection or radio link monitoring; or resuming the counter N310 with a previous counter value of the counter N310 after enabling radio problem detection or radio link monitoring, wherein the previous counter value is a counter value of the counter N310 before or at the beginning of the positioning gap.

In some embodiments, an RRC layer of the UE indicates a lower layer of the UE to disable the radio problem detection or radio link monitoring or enable the radio problem detection or radio link monitoring.

In some embodiments, in the case that the positioning gap is configured after a radio link failure being declared, the radio link management is associated with a radio link control process, which includes at least one of the following: applying value 0 to a counter N310 and applying value 0 to a timer T310 before or at the beginning of the positioning gap; suspending a transmission of an RRC reestablishment request until the end of the positioning gap; transmitting the RRC reestablishment request before or at the beginning of the positioning gap, including an indication which indicates the BS to suspend a response to the RRC reestablishment request until the end of the positioning gap; transmitting a random access preamble using a dedicated PRACH resource at or after the end of the positioning gap; or applying an extended value to a timer T301 before or at the beginning of the positioning gap.

In some embodiments, the radio link management is associated with uplink synchronization, which includes at least one of the following: acquiring ephemeris data of a serving radio access network (RAN) node of the UE before the beginning of the positioning gap; updating a UE-specific timing advance (TA) based on a result of the positioning and valid ephemeris data after the end of the positioning gap; updating a total TA as the UE-specific TA plus a valid common TA after the end of the positioning gap; transmitting an RRC re-establishment request using the updated total TA; or reporting an updated total TA or an updated UE-specific TA after the end of the positioning gap.

In some embodiments, in the case that acquired ephemeris data is invalid at or after the end of the positioning gap, the processor is further configured to: acquire ephemeris data of the serving RAN node of the UE after the end of the positioning gap.

In some embodiments, in the case that the positioning gap is configured, and the UE is an narrow band internet of things (NB-IoT) UE, the radio link management is associated with cell measurement, which includes at least one of the following: disabling at least one measurement of a serving cell before or at the beginning of the positioning gap; enabling at least one measurement of the serving cell at or after the end of the positioning gap; stopping evaluating at least one of the criteria for neighbour cell measurement before or at the beginning of the positioning gap; starting evaluating at least one of the criteria for neighbour cell measurement at or after the end of the positioning gap; disabling triggering neighbour cell measurement before or at the beginning of the positioning gap; or enabling triggering neighbour cell measurement at or after the end of the positioning gap.

In some embodiments, in the case that the positioning gap is configured, the UE is not an NB-IoT UE, the radio link management is associated with cell measurement, which includes at least one of the following: disabling at least one measurement of a serving cell before or at the beginning of the positioning gap; enabling at least one measurement of the serving cell at or after the end of the positioning gap; stopping evaluating at least one event in a measurement report configuration before or at the beginning of a positioning gap; starting evaluating at least one event in the measurement report configuration at or after the end of the positioning gap; disabling a measurement report before or at the beginning of the positioning gap; or enabling a measurement report at or after the end of the positioning gap.

In some embodiments, the radio link management is associated with transmitting positioning assistance information, which includes at least one of the following: an indication indicating that the positioning of the UE is needed; an adjustment to the positioning gap; or a time duration in which the UE is out of coverage.

Another embodiment of the present disclosure provides a base station (BS), comprising: a transceiver; and a processor coupled with the transceiver and configured to: generate first configuration information which configures a UE to perform radio link management associated with a positioning gap configuration; and transmit the first configuration information to the UE.

In some embodiments, the processor is further configured to: transmit second configuration information which configures the UE to perform the positioning operation.

In some embodiments, the processor is further configured to: receive, from the UE, an indication indicating that positioning of the UE is needed.

In some embodiments, in the case that the positioning gap is configured, the radio link management is associated with a radio link control process, which includes at least one of the following: disabling all access stratum (AS) functions before or at the beginning of the positioning gap; enabling all AS functions at or after the end of the positioning gap; disabling radio problem detection or radio link monitoring before or at the beginning of the positioning gap; enabling radio problem detection or radio link monitoring at or after the end of the positioning gap; applying an extended value to a counter N310 before or at the beginning of the positioning gap; applying an extended value to a timer T310 before or at the beginning of the positioning gap; or suspending transmission of an RRC reestablishment request until the end of the positioning gap; transmitting the RRC reestablishment request before or at the beginning of the positioning gap, including an indication which indicates the BS to suspend a response to the RRC reestablishment request until the end of the positioning gap; transmitting a random access preamble using a dedicated PRACH resource at or after the end of the positioning gap; or applying an extended value to a timer T301 before or at the beginning of the positioning gap.

In some embodiments, the radio link control process further includes: starting the counter N310 from value 0 after enabling radio problem detection or radio link monitoring; or resuming the counter N310 with a previous counter value of the counter N310 after enabling radio problem detection or radio link monitoring, wherein the previous counter value is a counter value of the counter N310 before or at the beginning of the positioning gap.

In some embodiments, in the case that a positioning gap is configured after a radio link failure being declared, the radio link management is associated with a radio link control process, which includes at least one of the following: applying value 0 to a counter N310 and applying value 0 to a timer T310 before or at the beginning of the positioning gap; suspending a transmission of an RRC reestablishment request until the end of the positioning gap; transmitting the RRC reestablishment request before or at the beginning of the positioning gap, including an indication which indicates the BS to suspend a response to the RRC reestablishment request until the end of the positioning gap; transmitting a random access preamble using a dedicated PRACH resource at or after the end of the positioning gap; or applying an extended value to a timer T301 before or at the beginning of the positioning gap.

In some embodiments, the radio link management is associated with uplink synchronization, which includes at least one of the following: acquiring ephemeris data of a serving RAN node of the UE before the beginning of a positioning gap; updating a UE-specific TA based on a result of the positioning and valid ephemeris data after the end of the positioning gap; updating a total TA as the UE-specific TA plus a valid common TA after the end of the positioning gap; transmitting an RRC re-establishment request using the updated total TA; or reporting an updated total TA or an updated UE-specific TA after the end of the positioning gap.

In some embodiments, in the case that the UE is an NB-IoT UE, the radio link management is associated with cell measurement, which includes at least one of the following: disabling at least one measurement of a serving cell before or at the beginning of a positioning gap; enabling at least one measurement of the serving cell at or after the end of the positioning gap; stopping evaluating at least one of the criteria for neighbour cell measurement before or at the beginning of a positioning gap; starting evaluating at least one of the criteria for neighbour cell measurement at or after the end of the positioning gap; disabling triggering neighbour cell measurement before or at the beginning of a positioning gap; or enabling triggering neighbour cell measurement at or after the end of the positioning gap.

In some embodiments, in the case that the UE is not an NB-IoT UE, the radio link management is associated with cell measurement, which includes at least one of the following: disabling at least one measurement of a serving cell before or at the beginning of a positioning gap; enabling at least one measurement of the serving cell at or after the end of the positioning gap; stopping evaluating at least one event in a measurement report configuration before or at the beginning of a positioning gap; starting evaluating at least one event in the measurement report configuration at or after the end of the positioning gap; disabling a measurement report before or at the beginning of the positioning gap; or enabling a measurement report at or after the end of the positioning gap.

In some embodiments, the radio link management is associated with transmitting positioning assistance information, which includes at least one of the following: an indication indicating that positioning of the UE is needed; an adjustment to the positioning gap; or a time duration in which the UE is out of coverage.

Yet another embodiment of the present disclosure provides a method performed by a UE, comprising: determining a positioning gap configuration for positioning of the UE; performing radio link management associated with the positioning gap configuration; and determining a position of the UE during the positioning gap.

Still another embodiment of the present disclosure provides a method performed by a BS, comprising: generating first configuration information which configures a UE to perform radio link management associated with a positioning gap configuration; and transmitting the first configuration information to the UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an NTN system according to some embodiments of the present disclosure.

FIG. 2 illustrates a radio link control process according to some embodiments of the present disclosure.

FIG. 3 illustrates a method performed by a UE for radio link management according to some embodiments of the present disclosure.

FIG. 4 illustrates a method performed by a BS for radio link management according to some embodiments of the present disclosure.

FIG. 5 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, an LTE network, a 3rd generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates an NTN system according to some embodiments of the present disclosure. The NTN may refer to a network, or segment of networks using radio frequency (RF) resources on board a satellite.

As shown in FIG. 1, the network may include a UE and an RAN node. The RAN node may be a satellite, or an unmanned aircraft systems (UAS) platform. Although only one UE and one satellite/UAS platform are depicted in FIG. 1, it is contemplated that any number of UEs and satellites/UAS platforms may be included in the wireless communication system.

The UE may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE includes wearable devices, such as smart watches, fitness bands, optical head-mounted displays, or the like. Moreover, the UE may be referred to as subscriber units, mobiles, mobile stations, users, terminals, mobile terminals, wireless terminals, fixed terminals, subscriber stations, user terminals, a device, or by other terminology used in the art. The UE may communicate directly with the satellite BS via service link. The UE may also perform sidelink transmission.

A typical terrestrial communication network includes one or more BSs that are located on earth (i.e., not airborne or spaceborne) that each provides geographical radio coverage, and UEs that can transmit and receive data within the radio coverage. In the terrestrial communication network, a BS and a UE can communicate with each other via a communication link, e.g., via a downlink radio frame from the BS to the UE or via an uplink radio frame from the UE to the BS.

The RAN node (e.g. a satellite) may include low earth orbiting (LEO) satellites orbiting around the Earth, medium earth orbiting (MEO) satellites, geostationary earth orbiting (GEO) satellites with fixed location to the Earth, as well as highly elliptical orbiting (HEO) satellites. In accordance with various embodiments, the satellite may be implemented with either a transparent or a regenerative payload. When the satellite carries a transparent payload, it performs only radio frequency filtering, frequency conversion and/or amplification of signals on board. Hence, the waveform signal repeated by the payload is un-changed. When a satellite carries a regenerative payload, in addition to performing radio frequency filtering, frequency conversion and amplification, it performs other signal processing functions such as demodulation/decoding, switching and/or routing, coding/decoding and modulation/demodulation on board as well. In other words, for a satellite with a regenerative payload (all or a part of base station functions (e.g., a gNB, eNB, etc.) are implemented on board.

A UAS platform(s) may include unmanned aircraft systems (UAS) including a tethered UAS and lighter than air UAS (LTA), heavier than air UAS (HTA), and high altitude platforms UAS (HAPs).

Hereinafter in the present disclosure, the RAN node may include: satellites that carry a transparent payload, satellites that carry a regenerative payload, a UAS platform(s), a BS, or the like.

The wireless communication system as shown in FIG. 1 may be compliant with any type of network that is capable of sending and receiving wireless communication signals. For example, the wireless communication system is compliant with a wireless communication network, a cellular telephone network, a time division multiple access (TDMA)-based network, a code division multiple access (CDMA)-based network, an orthogonal frequency division multiple access (OFDMA)-based network, an LTE network, a 3rd generation partnership project (3GPP)-based network, a 3GPP 5G network, a satellite communications network, a high altitude platform network, and/or other communications networks.

In one implementation, the wireless communication system is compliant with the NR of the 3GPP protocol, wherein the BS transmits using an OFDM modulation scheme on the DL and the UE transmits on the UL using a single-carrier frequency division multiple access (SC-FDMA) scheme or OFDM scheme. More generally, however, the wireless communication system may implement some other open or proprietary communication protocol, for example, WiMAX, among other protocols.

In other embodiments, the BS may communicate using other communication protocols, such as the IEEE 802.11 family of wireless communication protocols. Further, in some embodiments the BS may communicate over a licensed spectrum, while in other embodiments the BS may communicate over an unlicensed spectrum. The present disclosure is not intended to be limited to the implementation of any particular wireless communication system architecture or protocol. In another embodiment, the BS may communicate with the UE using 3GPP 5G protocols.

A UE that supports NTN features may be assumed to have GNSS capability, and the UE may perform the GNSS operations. For example, acquiring its position and thus deriving its timing advance based on the satellite ephemeris for uplink synchronization. Due to the RF hardware and capability restriction of the UE, the GNSS operations and data transmission or reception may not be performed simultaneously. As a result, when the UE needs to perform a GNSS operation, for example, acquiring the GNSS position when it is to become out-of-date, the UE may leave the RRC_CONNECTED state and may enter into the RRC_IDLE state to perform the GNSS operations.

For Rel-18 IoT NTN with further considerations on optimization and UE power saving, the GNSS operation may be optimized with sparse use of GNSS and power efficiency for long-term connection. Therefore, it is advantageous to allow the UE to perform the GNSS operations in the RRC_CONNECTED state without entering into the RRC_IDLE state.

However, there are some issues when the UE may perform the GNSS operations in the RRC_CONNECTED state.

A GNSS operation may take seconds or tens of seconds, and a UE may not perform the GNSS operation and data transmission/reception simultaneously. To allow the UE to perform GNSS operations in the RRC_CONNECTED state, the network may configure at least one GNSS operation gap (a time duration for performing the GNSS operation, for example, a positioning gap), during which the UE and the network may stop data transmission and reception, so that UE can switch its RF to acquire the GNSS position (e.g., by receiving measurement signals from GNSS satellites).

The length of a time duration (e.g., for neighbour cell measurements) may be configured in milliseconds, i.e., 20 ms, 40 ms, 80 ms and 160 ms, which has very little impact on UE operations, such as the following UE operations: 1) radio link monitoring (RLM) or radio link failure (RLF) handling; 2) uplink synchronization; and 3) NB-IoT neighbour cell measurement triggering in the RRC_CONNECTED state. However, a GNSS operation may usually take seconds or tens of seconds. For example, the GNSS position fix may take 30 s-40 s for a cold start (after tens of minutes off of the GNSS module), 10 s-15 s for a warm start (after minutes off of the GNSS module), and 3 s-5 s for a hot start (the GNSS module is always on). Therefore, the GNSS operation duration may render the UE unable to maintain or resume the RRC connection during or after such a long GNSS operation duration following legacy mechanisms in an LTE system or an NR system.

More specifically, there may be the following issues:

Issue 1: the RLF and possible state transition may be caused by a long GNSS operation duration.

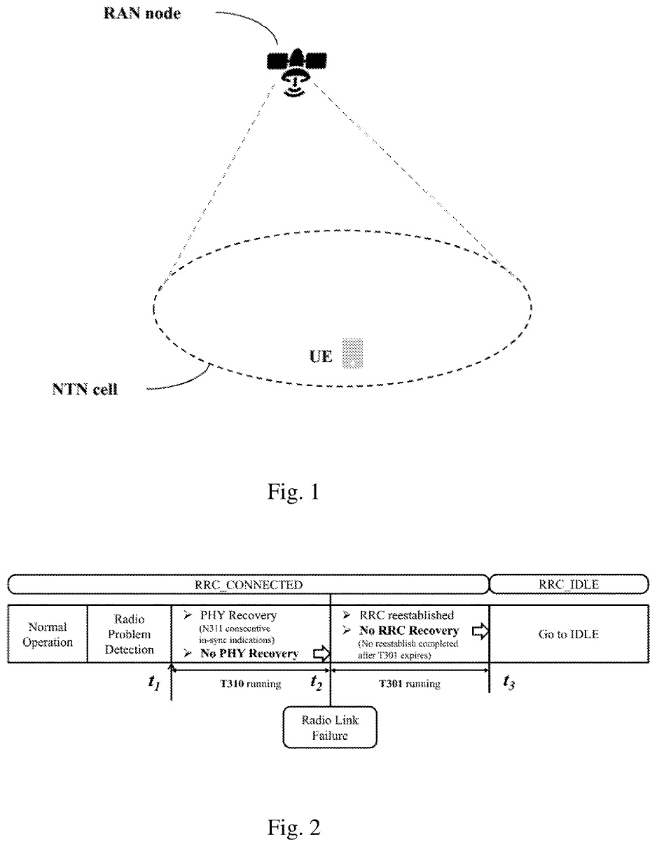

FIG. 2 illustrates a radio link control process according to some embodiments of the present disclosure.

In the RRC_CONNECTED state, a UE may perform normal operations. The physical layer may perform radio problem detection or radio link monitoring. At time t1, the UE may receive indications, e.g. N310 consecutive out-of-sync indications, from lower layers (e.g. physical layer), which indicate that physical layer related problems are detected, and the UE may start timer T310. The maximum value for timer T310 may be 6 s for normal UEs, and may be 8 s for NB-IoT UEs.

When timer T310 is running, in the case that indications (e.g. N311 consecutive in-sync indications) are received, the radio link is recovered, and the timer T310 is stopped. In the case that N311 consecutive in-sync indications are not received and the timer T310 expires (at time t2), the radio link is not recovered, and the UE may declare a radio link failure. The UE (e.g. the RRC layer of the UE) may transmit an RRC connection re-establishment request, and start a timer T301. The maximum value for timer T301 may be 10 s for normal UEs and may be 120 s for NB-IoT UEs. When the timer T301 expires, and the RRC connection re-establishment is not completed, at time t3, the UE may enter into the RRC_IDLE state.

In the present disclosure, the time duration for performing the GNSS operations (e.g. GNSS position fix), may be configured (such as explicitly configured by the network or by specification), or may be configured after the RLF declaration (e.g. implicitly placed after the RLF declaration, which may be specified by specification, or by UE implementation, etc.). Hereinafter the time duration for performing the GNSS position fix may be referred to as a positioning gap. The GNSS position fix is used for explaining the solutions of the present disclosure, and it should be noted that other GNSS operations, or other non-GNSS operations may also be applied in the present disclosure.

### Case 1-1: the Positioning Gap is Configured:

As mentioned above, the GNSS operations and data transmission or reception may not be performed simultaneously. Accordingly, a radio problem may be detected after the start of the positioning gap, and the timer T310 may be started. Depending on the time duration of the positioning gap and the timer T310 value, several scenarios are presented as follows:
a) the time duration of the positioning gap is shorter than the timer T310 value:
   i. The UE may receive N311 consecutive in-sync indications in time for physical layer recovery after the positioning gap, that is, a radio link is recovered, and thus an RLF may not be declared.
   ii. The UE may not receive N311 consecutive in-sync indications for physical layer recovery after the positioning gap, and thus an RLF may be declared.
b) the time duration of the positioning gap is equal to or longer than the timer T310 value:

The UE may not receive N311 consecutive in-sync indications when timer T310 is running. Therefore, when timer T310 expires, an RLF may certainly be declared.

Once the RLF is declared, the UE may transmit an RRC reestablishment request, which may also be restricted by the positioning gap. Depending on the time duration of the positioning gap, the timer T310 value, and the timer T301 value, several scenarios are presented as follows:
a) the time duration of the positioning gap is shorter than the sum of the timer T310 value and the timer T301 value:
   i. The UE may transmit an RRC reestablishment request and may receive the RRC reestablishment configuration in time for RRC recovery after the positioning gap, that is, the radio link is recovered, and thus the UE may stay in the RRC_CONNECTED state.
   ii. The UE may transmit the RRC reestablishment request, but may not receive the RRC reestablishment configuration in time for RRC recovery after the positioning gap, that is, the RRC reestablishment is not successful, and thus the UE may enter into the RRC_IDLE state.
b) the time duration of the positioning gap is equal to or longer than the sum of the timer T310 value and the timer T301 value:

The UE may transmit an RRC reestablishment request, but may not receive the RRC reestablishment configuration in time for RRC recovery after the positioning gap, that is, the RRC reestablishment is not successful, and thus the UE may certainly enter into the RRC_IDLE state.

### Case 1-2: the Positioning Gap is Placed After the RLF Being Declared:

Once the RLF is declared, the UE may start the timer T301, and may transmit an RRC reestablishment request, which may be restricted by the time duration of the positioning gap. Depending on the time duration of the positioning gap and the timer T301 value, several scenarios are presented as follows:
a) the time duration of the positioning gap is shorter than the timer T301 value:
   i. The UE may transmit an RRC reestablishment request and may receive the RRC reestablishment configuration in time for RRC recovery after the positioning gap, that is, the radio link is recovered, and thus the UE may stay in the RRC_CONNECTED state.
   ii. The UE may transmit an RRC reestablishment request, but may not receive the RRC reestablishment configuration in time for RRC recovery after the positioning gap, that is, the RRC reestablishment is not successful, and thus the UE may enter into the RRC_IDLE state.
b) the time duration of the positioning gap is equal to or longer than the timer T301 value:

The UE may transmit an RRC reestablishment request, but may not receive the RRC reestablishment configuration in time for RRC recovery after the positioning gap, that is, the RRC reestablishment is not successful, and thus the UE may certainly enter into the RRC_IDLE state In view of the above, for both case 1-1 and case 1-2, when the timer T301 value is not long enough, the UE may enter into the RRC_IDLE state. For case 1-1, when the timer T310 value is not long enough, the UE may declare an RLF.

Issue 2: the uplink synchronization may loss due to a long duration of the positioning gap.

The positioning operation, for example, GNSS position fix, may be used by the UE to obtain valid UE position information, which is a necessary element for uplink synchronization.

There are three necessary elements for uplink synchronization, which are:
a) valid UE position information;
b) valid ephemeris data of the serving satellite, so that UE can calculate UE-specific TA; and
c) valid cell-specific common TA, which may be provided by the network together with satellite ephemeris, so that the UE can calculate the total TA as UE-specific TA plus common TA for uplink synchronization.

In some cases, the NTN UE may also report the TA to the network when the UE is requested by the network.

Depending on the validity of the ephemeris data and the time duration of the positioning gap, several cases are presented as follows:

### Case 2-1: The Ephemeris Data Becomes Invalid During a Long Time Duration of the Positioning Gap.

The received ephemeris data may only be used in a valid time duration starting at an epoch time, and the UE may need to re-acquire new ephemeris data before the end of the valid duration or after the end of the valid duration.

In the case that the end of the valid duration is during the time duration of the positioning gap, the UE may be unable to re-acquire new ephemeris data until the end of the positioning gap, and only after the positioning gap shall the UE calculate its TA for uplink synchronization, which may further prolong the time duration before reconnection.

### Case 2-2: The TA is Updated After Experiencing a Long Positioning Gap.

An NTN timing advance report (TAR) is used to help the network understand the actual propagation delay in further scheduling. The UE may report the TAR once in random access procedures if network broadcasts an indication, and/or report the TAR once in the RRC_CONNECTED state if no TAR is reported during the connection procedure. During the connection procedure, the network may adjust the TA by a timing advance command (TAC) to ensure uplink synchronization.

After a long time duration of the positioning gap, both the location of the UE and the location of the RAN node (i.e. the satellite) may have changed a lot, and thus the TA may need to be updated. The differential TA (i.e. the difference between a first TA value before the positioning gap and a second TA value after the positioning gap) may exceed the limit of the TAC (which may be 0.017 ms), resulting in that the network cannot update its knowledge of UE's TA by the TAC.

Issue 3: Triggering of neighbour cell measurement in the RRC_CONNECTED state due to a long positioning gap.

In Rel-17, the criteria of triggering neighbour cell measurement in RRC_CONNECTED state for NB-IoT UEs is a combination of serving cell reference signal receiving power (RSRP) and its variance. That is, if the measured serving cell RSRP is lower than a threshold and its variance compared to a reference RSRP is higher than a threshold, the UE may perform neighbour cell measurements.

In the case that a positioning gap is configured, during the positioning gap, the NB-IoT UE may not receive any signal from the network including the reference signal for RSRP measurement, and as a result the neighbour cell measurement may be triggered with a corresponding RF switch.

Meanwhile, a similar issues may also occur for normal UEs and eMTC UEs configured with measurement objects, especially when events regarding serving cell RSRP are configured.

Issue 4: the UE movement may invalidate the result of the previous GNSS operation, e.g. the previous GNSS position fix, or invalidate the time duration for performing the positioning operation.

Currently, only the network-triggered GNSS position fix is supported. That is, the network may trigger the UE to perform the positioning operation, e.g. GNSS position fix. The UE may not perform the positioning operation by itself.

However, the UE movement may also invalidate its previous GNSS position fix result, while the network is unaware that the UE needs to re-acquire GNSS position, i.e. the UE needs to perform the positioning operation. Accordingly, the network may not configure a time duration (i.e. a positioning gap) for the UE to perform the positioning operation, and data transmission or reception continues until the uplink synchronization is lost. In addition, for the discontinuous coverage scenario, when configuring a duration for the UE to perform the positioning fix, the network may not be aware of the time duration in which the UE will be out of coverage. Accordingly, during the positioning gap, the UE may be out of coverage, thus the UE may be unable to reconnect to the network after the positioning gap.

In the above issues, the positioning operation is described as an example, and it should be noted that these issues may also exist for performing other operations, such as a GNSS positioning operation, a non-GNSS positioning operation (e.g. a positioning operation with a long time period which may be longer than the timer T310 value, the timer T301 value, or the sum of the timer T310 value and the timer T301 value), or other GNSS operations.

The present disclosure proposes some solutions for solving the above issues, for example, some solutions for radio link management. Hereinafter in the present disclosure, a positioning operation is used for describing the solutions, which may include a GNSS positioning operation, and/or a non-GNSS positioning operation. It should be noted that the solutions also apply to other types of operations, such as any operation that may cause the UE to transit from the RRC_CONNECTED state to the RRC_IDLE state (or the RRC_INACTIVE state). In some embodiments, the positioning operation may be indicated by the BS, for example, by configuration information (or configuration message(s), configuration signalling(s), or the like). In some other embodiments, the positioning operation may be performed by the UE based on the determination of the UE. For example, in the case that the UE determines the location of the UE has changed, and the distance between a previous location of the UE and the current location of the UE exceeds a threshold, the UE may determine to perform the positioning operation.

Hereinafter in the present disclosure, the expression “positioning gap” may be used to refer to the time duration for performing the positioning operation, i.e. position fix. For other operations, such as another GNSS operation, the expression “positioning gap” may be replaced by the expression “a time duration for a GNSS operation,” and the solutions also apply for the GNSS operation. Other expressions for the time duration may also be applied.

### Solution 1:

In this solution, the radio link management may relate to the enhancements of the radio link control process, such as adjusting radio link monitoring (RLM) handling, adjusting RLF handling, or both. Adjusting the radio link control process may be indicated by the network, for example, the BS may transmit configuration information (or configuration message(s), configuration signalling(s), or the like), indicating the UE to adjust the radio link control process. Alternatively, adjusting the radio link control process may be specified, for example, in the specification, and the UE may handle the RLM or RLF accordingly. Alternatively, adjusting the radio link control process may be performed by UE implementation. The detailed solutions are presented as follows:

### Solution 1-1: The Time Duration of the Positioning Gap is Configured.

The radio link control process (e.g. adjusting the RLM handling or adjusting the RLF handling) may include at least one of the following:
a) Regarding the AS functions, the UE may perform at least one of the following:
   i. Before the beginning of the positioning gap, or at the beginning of the positioning gap, disabling (or suspending) all AS functions; and/or
   ii. At the end of the positioning gap, or after the end of the positioning gap, enabling (or resuming) all AS functions.
b) Regarding the radio problem detection or radio link monitoring, the RRC layer may indicate lower layers to perform at least one of the following:
   i. Before the beginning of the positioning gap, or at the beginning of the positioning gap, disabling (or suspending) radio problem detection or radio link monitoring; and/or
   ii. At the end of the positioning gap, or after the end of the positioning gap, enabling (or resuming) radio problem detection or radio link monitoring.
c) Regarding the Counter N310:
   i. Before the beginning of the positioning gap, or at the beginning of the positioning gap, apply an extended value to the counter N310, for example, the extended value may be larger than 20. The value may be large enough, for example, 100, 200, etc., to cover the positioning gap, or set the value of the counter N310 as infinite; and/or
   ii. At the end of the positioning gap, or after the end of the positioning gap, resume the value of the counter N310 with the counter value for the counter N310 at the beginning of the positioning gap, or start the value of the counter N310 with value 0.
   Upon enabling or resuming radio problem detection or radio link monitoring at the end of the gap, the UE may continue to use the counter value for the counter N310 at the beginning of the positioning gap, or start the value of the counter N310 from 0. For example, at the beginning of the positioning gap, the value of the counter N310 is 5, and the counter N310 is disabled (or suspended). At the end of the positioning gap, the counter N310 is enabled (or resumed) with the value 5; or, the counter N310 is enabled (or resumed) with the value 0.
d) Regarding the timer T310: at the beginning of the positioning gap, applying an extended value to the timer T310, for example, the extended value may be larger than 6 s for normal UEs, or larger than 8 s for NB-IoT UEs. The value may be large enough, for example, 50 s, 100 s, etc., to cover the positioning gap, or the value of the timer T310 may be set as infinite.
e) Suspending transmission of an RRC reestablishment request until the end of the positioning gap.
f) Before the beginning of the positioning gap, or at the beginning of the positioning gap, transmitting the RRC reestablishment request including an indication which indicates the BS to suspend a response to the RRC reestablishment request until the end of the positioning gap.
g) At the end of the positioning gap, or after the end of the positioning gap, transmitting a random access preamble using a dedicated PRACH resource; or
h) Regarding the timer T301: before the beginning of the positioning gap, or at the beginning of the positioning gap, set the value of the timer T301 to a value large enough, for example, 100 s, 200 s, etc., to cover the positioning gap, or set the value of the timer T301 as infinite.

### Solution 1-2: The Positioning Gap is After the RLF Declaration.

The radio link control process (e.g. adjusting the RLM handling or adjusting the RLF handling) may include at least one of the following:
a) Regarding the counter N310 and the timer T310: before the beginning of the positioning gap, or at the beginning of the positioning gap, setting the value of the counter N310 to value 0 and the value of the timer T310 to value 0, to trigger the RLF directly. In this way, the RLF is triggered directly, and the UE may perform the positioning operation.
b) Suspending transmission of an RRC reestablishment request until the end of the positioning gap.
c) Before the beginning of the positioning gap, or at the beginning of the positioning gap, transmitting the RRC reestablishment request including an indication which indicates the BS to suspend a response to the RRC reestablishment request until the end of the positioning gap.
d) At the end of the positioning gap, or after the end of the positioning gap, transmitting a random access preamble using a dedicated PRACH resource; or
e) Regarding the timer T301: before the beginning of the positioning gap, or at the beginning of the positioning gap, applying an extended value to the timer T310, for example, the extended value may be larger than 6 s for normal UEs, or larger than 8 s for NB-IoT UEs. The value may be large enough, for example, 50 s, 100 s, etc., to cover the positioning gap, or the value of the timer T301 may be set as infinite.

### Solution 2

In this solution, the radio link management may be associated with uplink synchronization. The UE may acquire the ephemeris data of the RAN node (e.g. the serving RAN node of the UE) before the beginning of the positioning gap. For example, the UE may acquire the system information that includes the ephemeris data (e.g., a system information block 31 (SIB31) for an LTE system, or a SIB19 for an NR system); alternatively, the UE may acquire the ephemeris data with dedicated signalling(s). In some embodiments, the UE may acquire the ephemeris data of the RAN node before the beginning of the positioning gap only when the end of the validity duration of the current ephemeris data is earlier than the end of the positioning gap. In some other embodiments, the UE may always acquire the ephemeris data of the RAN node before the beginning of the positioning gap.

In some embodiments, the end of the validity duration of the acquired ephemeris data may still be earlier than the end of the positioning gap, in other words, the acquired ephemeris data may still be invalid after the positioning gap, then the UE may acquire the ephemeris data of the RAN node at the end of the positioning gap or after the end of the positioning gap.

At the end of the positioning gap or after the end of the positioning gap, the UE may perform at least one of the following:
a) Updating the UE-specific TA, and the UE-specific TA may be updated with the result of the positioning operation, and the valid ephemeris data. For example, the UE may have determined the updated position of the UE and the updated position of the RAN node, and may determine the UE-specific TA based on the updated positions and the valid ephemeris data of the RAN node.
b) Updating the total TA, which may equal the sum of the updated UE-specific TA and a valid common TA.
c) Transmitting an RRC re-establishment request using the updated total TA. In some embodiments, the RRC re-establishment request is transmitted in the case that the positioning gap is after the RLF declaration.
d) Reporting, to the network, the updated total TA, the updated UE-specific TA, or both. It should be noted that the UE may report the updated total TA, the updated UE-specific TA regardless of whether the condition for reporting the TA for the RRC_CONNECTED state is fulfilled or not.

### Solution 3

In this solution, the radio link management may be associated with the cell measurement. Regarding cell measurement for a UE in the RRC_CONNECTED state, and a positioning gap being configured, the UE may perform at least one of the following:
i. Before the beginning of the positioning gap, or at the beginning of the positioning gap, disabling (or suspending) at least one of the measurements of the serving cell, which may include the RSRP measurement, the distance calculation to the reference location, the channel busy ratio, or the aerial UE height, etc.; and/or
ii. At the end of the positioning gap, or after the end of the positioning gap, enabling (or resuming) at least one of the measurements of the serving cell.

In the case that the UE is an NB-IoT UE, regarding the neighbour cell measurement in the RRC_CONNECTED state, the UE may further perform at least one of the following:
i. Before the beginning of the positioning gap, or at the beginning of the positioning gap,
   1. Stopping evaluating at least one of the criteria for neighbour cell measurement. For example, stop evaluating the RSRP or the RSRP variation of the neighbour cell; or stop evaluating the distance or distance variation to the reference location, etc.; and/or
   2. Disabling triggering neighbour cell measurement.
ii. At the end of the positioning gap, or after the end of the positioning gap,
   1. Starting to evaluate at least one of the criteria for neighbour cell measurement. For example, start evaluating the RSRP or the RSRP variation of the neighbour cell; or start evaluating the distance or distance variation to the reference location, etc.; and/or
   2. Enabling triggering neighbour cell measurement.

In the case that the UE is not an NB-IoT UE, the UE may further perform at least one of the following:
i. Before the beginning of the positioning gap, or at the beginning of the positioning gap,
   1. Stopping evaluating at least one of the events in the measurement report configuration. The events may include: event A1-A6,B1-B2, C1-C2, W1-W3, V1-V2 or H1-H2; and/or
   2. Disabling the measurement report.
ii. At the end of the positioning gap, or after the end of the positioning gap,
   1. Starting evaluating at least one of the events in the measurement report configuration. The events may include at least one of the following: Event A1-A6, B1-B2, C1-C2, W1-W3, V1-V2 or H1-H2; and/or
   2. Enabling the measurement report.

### Solution 4

In this solution, the radio link management may be associated with transmitting assistance information to the network, and the assistance information may include at least one of the following:
a) An indication indicating that a positioning operation (or a GNSS positioning operation, a GNSS operation, a non-GNSS positioning operation, or the like) is needed at UE, e.g., due to UE movement.
b) An adjustment to a configured positioning operation pattern (or a GNSS positioning operation pattern, a GNSS operation pattern, a non-GNSS positioning operation pattern, or the like). For example, adjusting the length of the duration of the positioning operation, such as from 30 s to 10 s, etc. For an example, adjusting the duration of a continuous gap, or adjusting the gap length, applying an offset to a configured positioning gap, adjusting a repetition period of a non-continuous gap, or the like.
c) A duration in which the UE may be out of coverage in the case that the UE is in a discontinuous coverage scenario.

It should be noted that the above solutions may be performed when the UE is in the RRC_CONNECTED state, or in other states, such as an RRC_IDLE state, an RRC_ INACTIVE state, etc.

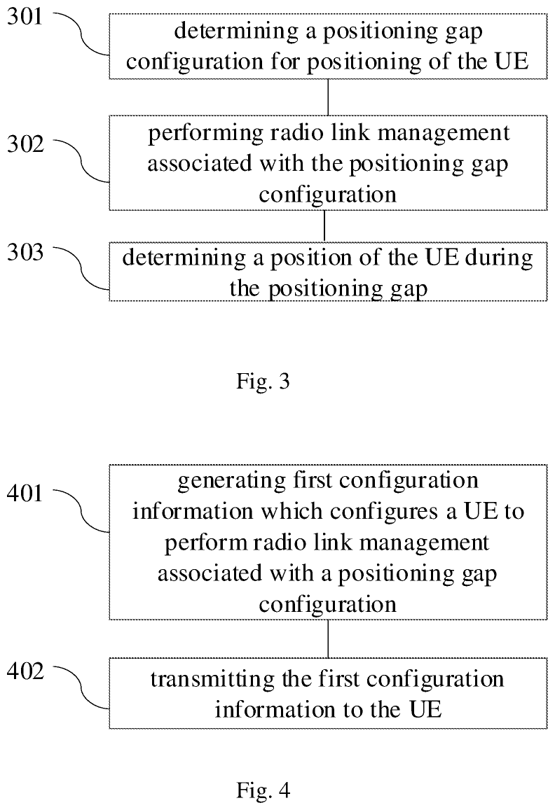

FIG. 3 illustrates a method performed by a UE for radio link management according to some embodiments of the present disclosure.

In operation 301, the UE may determine a positioning gap configuration for positioning of the UE; in operation 302, the UE may perform radio link management associated with the positioning gap configuration; and in operation 303, the UE may determine a position of the UE during the positioning gap.

FIG. 4 illustrates a method performed by a BS for radio link management according to some embodiments of the present disclosure.

In operation 401, the BS may generate first configuration information which configures a UE to perform radio link management associated with a positioning gap configuration; and in operation 402, the BS may transmit the first configuration information to the UE.

In some embodiments, the UE is in a radio resource control (RRC)_CONNECTED state.

In some embodiments, the positioning of the UE includes GNSS positioning or non-GNSS positioning.

In some embodiments, the radio link management is performed based on configuration information received from a BS, based on UE implementation, or based on pre-configured rules.

In some embodiments, the positioning is performed based on the positioning gap configuration received from a BS, or based on movement of the UE.

In some embodiments, in the case that the positioning gap is configured, the radio link management is associated with a radio link control process, which includes at least one of the following: disabling all AS functions before or at the beginning of the positioning gap; enabling all AS functions at or after the end of the positioning gap; disabling radio problem detection or radio link monitoring before or at the beginning of the positioning gap; enabling radio problem detection or radio link monitoring at or after the end of the positioning gap; applying an extended value to a counter N310 (for example, larger than 20) before or at the beginning of the positioning gap; applying an extended value to a timer T310 (for example, larger than 6 s for normal UEs, or 8 s for NB-IoT UEs, or infinite) before or at the beginning of the positioning gap; or suspending transmission of an RRC reestablishment request until the end of the positioning gap; transmitting the RRC reestablishment request before or at the beginning of the positioning gap, including an indication which indicates the BS to suspend a response to the RRC reestablishment request until the end of the positioning gap; transmitting a random access preamble using a dedicated PRACH resource at or after the end of the positioning gap; or applying an extended value to a timer T301 before or at the beginning of the positioning gap.

In some embodiments, the radio link control process further includes: starting the counter N310 from value 0 after enabling radio problem detection or radio link monitoring; or resuming the counter N310 with a previous counter value of the counter N310 after enabling radio problem detection or radio link monitoring, wherein the previous counter value is a counter value of the counter N310 before or at the beginning of the positioning gap.

In some embodiments, an RRC layer of the UE indicates a lower layer of the UE to disable the radio problem detection or radio link monitoring or enable the radio problem detection or radio link monitoring.

In some embodiments, in the case that the positioning gap is configured after a radio link failure being declared, the radio link management is associated with a radio link control process, which includes at least one of the following: applying value 0 to a counter N310 and applying value 0 to a timer T310 before or at the beginning of the positioning gap; suspending a transmission of an RRC reestablishment request until the end of the positioning gap; transmitting the RRC reestablishment request before or at the beginning of the positioning gap, including an indication which indicates the BS to suspend a response to the RRC reestablishment request until the end of the positioning gap; transmitting a random access preamble using a dedicated PRACH resource at or after the end of the positioning gap; or applying an extended value to a timer T301 before or at the beginning of the positioning gap.

In some embodiments, the radio link management is associated with uplink synchronization, which includes at least one of the following: acquiring ephemeris data of a serving RAN node of the UE before the beginning of the positioning gap; updating a UE-specific TA based on a result of the positioning and valid ephemeris data after the end of the positioning gap; updating a total TA as the UE-specific TA plus a valid common TA after the end of the positioning gap; transmitting an RRC re-establishment request using the updated total TA; or reporting an updated total TA or an updated UE-specific TA after the end of the positioning gap.

In some embodiments, in the case that acquired ephemeris data is invalid at or after the end of the positioning gap, the processor is further configured to: acquire ephemeris data of the serving RAN node of the UE after the end of the positioning gap.

In some embodiments, in the case that the positioning gap is configured, and the UE is an NB-IoT UE, the radio link management is associated with cell measurement, which includes at least one of the following: disabling at least one measurement of a serving cell before or at the beginning of the positioning gap; enabling at least one measurement of the serving cell at or after the end of the positioning gap; stopping evaluating at least one of the criteria for neighbour cell measurement before or at the beginning of the positioning gap; starting evaluating at least one of the criteria for neighbour cell measurement at or after the end of the positioning gap; disabling triggering neighbour cell measurement before or at the beginning of the positioning gap; or enabling triggering neighbour cell measurement at or after the end of the positioning gap.

In some embodiments, in the case that the positioning gap is configured, the UE is not an NB-IoT UE, the radio link management is associated with cell measurement, which includes at least one of the following: disabling at least one measurement of a serving cell before or at the beginning of the positioning gap; enabling at least one measurement of the serving cell at or after the end of the positioning gap; stopping evaluating at least one event in a measurement report configuration before or at the beginning of a positioning gap; starting evaluating at least one event in the measurement report configuration at or after the end of the positioning gap; disabling a measurement report before or at the beginning of the positioning gap; or enabling a measurement report at or after the end of the positioning gap.

In some embodiments, the radio link management is associated with transmitting positioning assistance information, which includes at least one of the following: an indication indicating that the positioning of the UE is needed; an adjustment to the positioning gap; or a time duration in which the UE is out of coverage.

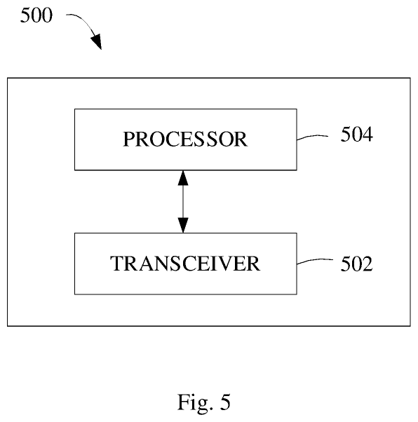

FIG. 5 illustrates a simplified block diagram of an apparatus according to some embodiments of the present disclosure.

As shown in FIG. 5, an example of the apparatus 500 may include at least one processor 504 and at least one transceiver 502 coupled to the processor 504. The apparatus 500 may be a UE, a BS, an RAN node, or any other device with similar functions.

Although in this figure, elements such as the at least one transceiver 502 and processor 504 are described in the singular, the plural is contemplated unless a limitation to the singular is explicitly stated. In some embodiments of the present disclosure, the transceiver 502 may be divided into two devices, such as a receiving circuitry and a transmitting circuitry. In some embodiments of the present disclosure, the apparatus 500 may further include an input device, a memory, and/or other components.

In some embodiments of the present disclosure, the apparatus 500 may be a UE. The transceiver 502 and the processor 504 may interact with each other so as to perform the operations of the UE described in any of FIGS. 1-4. In some embodiments of the present disclosure, the apparatus 500 may be a BS or an RAN node. The transceiver 502 and the processor 504 may interact with each other so as to perform the operations of the BS or the RAN node described in any of FIGS. 1-4.

In some embodiments of the present disclosure, the apparatus 500 may further include at least one non-transitory computer-readable medium.

For example, in some embodiments of the present disclosure, the non-transitory computer-readable medium may have stored thereon computer-executable instructions to cause the processor 504 to implement the method with respect to the UE as described above. For example, the computer-executable instructions, when executed, cause the processor 504 interacting with transceiver 502 to perform the operations of the UE described in any of FIGS. 1-4.

In some embodiments of the present disclosure, the non-transitory computer-readable medium may have stored thereon computer-executable instructions to cause the processor 504 to implement the method with respect to the BS or the RAN node as described above. For example, the computer-executable instructions, when executed, cause the processor 504 interacting with transceiver 502 to perform the operations of the BS or the RAN node described in any of FIGS. 1-4.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
determine a positioning gap configuration for positioning of the UE;
perform radio link management associated with the positioning gap configuration; and
determine a position of the UE during the positioning gap.

2. The UE of claim 1, wherein, in response to the positioning gap being configured, the radio link management is associated with a radio link control process which includes at least one of the following:
disabling all access stratum (AS) functions before or at a beginning of the positioning gap;
enabling all AS functions at or after an end of the positioning gap;
disabling radio problem detection or radio link monitoring before or at the beginning of the positioning gap;
enabling radio problem detection or radio link monitoring at or after the end of the positioning gap;
applying an extended value to a counter N310 before or at the beginning of the positioning gap;
applying an extended value to a timer T310 before or at the beginning of the positioning gap;
suspending transmission of a radio resource control (RRC) reestablishment request until the end of the positioning gap;
transmitting the RRC reestablishment request before or at the beginning of the positioning gap, including an indication which indicates a base station to suspend a response to the RRC reestablishment request until the end of the positioning gap;
transmitting a random access preamble using a dedicated physical random access channel (PRACH) resource at or after the end of the positioning gap; or
applying an extended value to a timer T301 before or at the beginning of the positioning gap.

3. The UE of claim 2, wherein an RRC layer of the UE indicates a lower layer of the UE to disable the radio problem detection or radio link monitoring or enable the radio problem detection or radio link monitoring.

4. The UE of claim 1, wherein, in response to the positioning gap being configured after a radio link failure being declared, the radio link management is associated with a radio link control process which includes at least one of the following:
applying value 0 to a counter N310 and applying value 0 to a timer T310 before or at a beginning of the positioning gap;
suspending a transmission of an RRC reestablishment request until [[the]] an end of the positioning gap;
transmitting the RRC reestablishment request before or at the beginning of the positioning gap, including an indication which indicates a base station to suspend a response to the RRC reestablishment request until the end of the positioning gap;
transmitting a random access preamble using a dedicated PRACH resource at or after the end of the positioning gap; or
applying an extended value to a timer T301 before or at the beginning of the positioning gap.

5. The UE of claim 1, wherein the radio link management is associated with uplink synchronization which includes at least one of the following:
acquiring ephemeris data of a serving radio access network (RAN) node of the UE before a beginning of the positioning gap;
updating a UE-specific timing advance (TA) based on a result of the positioning and valid ephemeris data after an end of the positioning gap;
updating a total TA as the UE-specific TA plus a valid common TA after the end of the positioning gap;
transmitting an RRC re-establishment request using the updated total TA; or
reporting an updated total TA or an updated UE-specific TA after the end of the positioning gap.

6. The UE of claim 1, wherein, in response to the positioning gap being configured, the radio link management is associated with cell measurement which includes at least one of the following:
disabling at least one measurement of a serving cell before or at a beginning of the positioning gap;
enabling at least one measurement of the serving cell at or after an end of the positioning gap;
stopping evaluating at least one of a criteria for neighbor cell measurement before or at the beginning of the positioning gap;
starting evaluating at least one of the criteria for neighbor cell measurement at or after the end of the positioning gap;
disabling triggering neighbor cell measurement before or at the beginning of the positioning gap; or enabling triggering neighbor cell measurement at or after the end of the positioning gap.

7. The UE of claim 1, wherein, in response to the positioning gap being configured and the UE is not an NB-IoT UE, the radio link management is associated with cell measurement which includes at least one of the following:
disabling at least one measurement of a serving cell before or at a beginning of the positioning gap;
enabling at least one measurement of the serving cell at or after an end of the positioning gap;
stopping evaluating at least one event in a measurement report configuration before or at the beginning of the positioning gap;
starting evaluating at least one event in the measurement report configuration at or after the end of the positioning gap;
disabling a measurement report before or at the beginning of the positioning gap; or enabling a measurement report at or after the end of the positioning gap.

8. The UE of claim 1, wherein the radio link management is associated with transmitting positioning assistance information which includes at least one of the following:
an indication indicating that the positioning of the UE is needed;
an adjustment to the positioning gap; or
a time duration in which the UE is out of coverage.

9. A base station comprising:
at least one memory; and
at least one processor coupled with the at least one memory and configured to cause the base station to:
generate first configuration information which configures a user equipment (UE) to perform radio link management associated with a positioning gap configuration; and
transmit the first configuration information to the UE.

10. The base station of claim 9, wherein, in response to the positioning gap being configured, the radio link management is associated with a radio link control process which includes at least one of the following:
disabling all access stratum (AS) functions before or at a beginning of the positioning gap;
enabling all AS functions at or after an end of the positioning gap;
disabling radio problem detection or radio link monitoring before or at the beginning of the positioning gap;
enabling radio problem detection or radio link monitoring at or after the end of the positioning gap;
applying an extended value to a counter N310 before or at the beginning of the positioning gap;
applying an extended value to a timer T310 before or at the beginning of the positioning gap;
suspending transmission of a radio resource control (RRC) reestablishment request until the end of the positioning gap;
transmitting the RRC reestablishment request before or at the beginning of the positioning gap, including an indication which indicates the BS to suspend a response to the RRC reestablishment request until the end of the positioning gap;
transmitting a random access preamble using a dedicated physical random access channel (PRACH) resource at or after the end of the positioning gap; or
applying an extended value to a timer T301 before or at the beginning of the positioning gap.

11. The base station of claim 9, wherein, in response to the positioning gap being configured after a radio link failure being declared, the radio link management is associated with a radio link control process which includes at least one of the following:
applying value 0 to a counter N310 and applying value 0 to a timer T310 before or at a beginning of the positioning gap;
suspending a transmission of a radio resource control (RRC) reestablishment request until an end of the positioning gap;
transmitting the RRC reestablishment request before or at the beginning of the positioning gap, including an indication which indicates the BS to suspend a response to the RRC reestablishment request until the end of the positioning gap;
transmitting a random access preamble using a dedicated PRACH resource at or after the end of the positioning gap; or applying an extended value to a timer T301 before or at the beginning of the positioning gap.

12. The base station of claim 9, wherein the radio link management is associated with uplink synchronization which includes at least one of the following:
acquiring ephemeris data of a serving radio access network (RAN) node of the UE before a beginning of the positioning gap;
updating a UE-specific timing advance (TA) based on a result of the positioning and valid ephemeris data after an end of the positioning gap;
updating a total TA as the UE-specific TA plus a valid common TA after the end of the positioning gap;
transmitting an RRC re-establishment request using the updated total TA; or reporting an updated total TA or an updated UE-specific TA after the end of the positioning gap.

13. The base station of claim 9, wherein, in response to the UE being an narrow band internet of things (NB-IoT) UE, the radio link management is associated with cell measurement which includes at least one of the following:
disabling at least one measurement of a serving cell before or at a beginning of the positioning gap;
enabling at least one measurement of the serving cell at or after an end of the positioning gap;
stopping evaluating at least one of a criteria for neighbor cell measurement before or at the beginning of the positioning gap;
starting evaluating at least one of the criteria for neighbor cell measurement at or after the end of the positioning gap;
disabling triggering neighbor cell measurement before or at the beginning of the positioning gap; or
triggering neighbor neighbour cell measurement at or after the end of the positioning gap.

14. The base station of claim 9, wherein, in response to the UE not being an NB-IoT UE, the radio link management is associated with cell measurement which includes at least one of the following:
disabling at least one measurement of a serving cell before or at a beginning of the positioning gap;
enabling at least one measurement of the serving cell at or after an end of the positioning gap;
stopping evaluating at least one event in a measurement report configuration before or at the beginning of the positioning gap;
starting evaluating at least one event in the measurement report configuration at or after the end of the positioning gap;
disabling a measurement report before or at the beginning of the positioning gap; or enabling a measurement report at or after the end of the positioning gap.

15. A method performed by a user equipment (UE), the method comprising:
determining a positioning gap configuration for positioning of the UE;
performing radio link management associated with the positioning gap configuration; and
determining a position of the UE during the positioning gap.

16. A processor for wireless communication, comprising:
at least one controller coupled with at least one memory and configured to cause the processor to:
determine a positioning gap configuration for positioning of the processor;
perform radio link management associated with the positioning gap configuration; and
determine a position of the processor during the positioning gap.

17. The processor of claim 16, wherein, in response to the positioning gap being configured, the radio link management is associated with a radio link control process which includes at least one of the following:
disabling all access stratum (AS) functions before or at a beginning of the positioning gap;
enabling all AS functions at or after an end of the positioning gap;
disabling radio problem detection or radio link monitoring before or at the beginning of the positioning gap;
enabling radio problem detection or radio link monitoring at or after the end of the positioning gap;
applying an extended value to a counter N310 before or at the beginning of the positioning gap;
applying an extended value to a timer T310 before or at the beginning of the positioning gap;
suspending transmission of a radio resource control (RRC) reestablishment request until the end of the positioning gap;
transmitting the RRC reestablishment request before or at the beginning of the positioning gap, including an indication which indicates a base station to suspend a response to the RRC reestablishment request until the end of the positioning gap,
transmitting a random access preamble using a dedicated physical random access channel (PRACH) resource at or after the end of the positioning gap; or
applying an extended value to a timer T301 before or at the beginning of the positioning gap.

18. The processor of claim 17, wherein an RRC layer of the processor indicates a lower layer of the processor to disable the radio problem detection or radio link monitoring or enable the radio problem detection or radio link monitoring.

19. The processor of claim 16, wherein, in response to the positioning gap being configured after a radio link failure being declared, the radio link management is associated with a radio link control process which includes at least one of the following:
applying value 0 to a counter N310 and applying value 0 to a timer T310 before or at a beginning of the positioning gap;
suspending a transmission of an RRC reestablishment request until an end of the positioning gap;
transmitting the RRC reestablishment request before or at the beginning of the positioning gap, including an indication which indicates a base station to suspend a response to the RRC reestablishment request until the end of the positioning gap;
transmitting a random access preamble using a dedicated PRACH resource at or after the end of the positioning gap; or
applying an extended value to a timer T301 before or at the beginning of the positioning gap.

20. The processor of claim 16, wherein the radio link management is associated with uplink synchronization which includes at least one of the following:
acquiring ephemeris data of a serving radio access network (RAN) node of the processor before a beginning of the positioning gap;
updating a UE-specific timing advance (TA) based on a result of the positioning and valid ephemeris data after an end of the positioning gap;
updating a total TA as the UE-specific TA plus a valid common TA after the end of the positioning gap;
transmitting an RRC re-establishment request using the updated total TA; or
reporting an updated total TA or an updated UE-specific TA after the end of the positioning gap.
